(19) United States
(12) Patent Application Publication
(10) Pub. No.: US 2012/0124817 A1
(43) Pub. Date: May 24, 2012

(54) FOOD SAFE CERAMIC SERVING TRAY AND RELATED METHOD

(75) Inventor: Adriana SINGH, Pennington, NJ (US)

(73) Assignee: ZYANYA DESIGNS LLC, Pennington, NJ (US)

(21) Appl. No.: 13/300,085

(22) Filed: Nov. 18, 2011

Related U.S. Application Data
(60) Provisional application No. 61/415,506, filed on Nov. 19, 2010.

(51) Int. Cl. B23P 17/00; B05D 7/00; B05D 3/02; B05D 5/00

(52) U.S. Cl. 29/527.2; 427/287

(57) ABSTRACT

A method of painting on a generally planar ceramic front surface of a tile in a food safe manner includes the steps of cleaning the front surface with a food safe cleaning agent, preparing a food safe paint to apply to the front surface, painting the front surface with the food safe paint in an aesthetically pleasing manner, resting front surface for a predetermine dwell time and heating the painted front surface to at least three hundred degrees Fahrenheit (300° F.) for at least thirty minutes (30 min). The predetermined dwell time is at least twelve hours (12 hrs).

### CROSS REFERENCE TO RELATED APPLICATIONS

This application claims priority to U.S. Provisional Patent Application No. 61/415,506, filed Nov. 19, 2010 and is incorporated herein by reference in its entirety.

### BACKGROUND OF THE INVENTION

Painting on surfaces and on tile surfaces for decorative purposes is generally known. Painting on such surfaces is typically conducted for aesthetic purposes to create a decorative piece. However, certain methods and materials utilized to paint ceramic surfaces result in a non-food safe product.

Certain ceramic tile trays are generally unsuited for serving food products, because they do not use food safe paint. These designs have room for improvement in safety and appearance. Converting existing tiles and techniques to prepare food serving trays is difficult and requires significant efforts using machinery and appliances that are not easily available. In addition, such products are generally not customizable and are produced in a relatively generic form that is often not aesthetically pleasing. It is desirable to design and develop a method and process for preparing a food safe, aesthetically pleasing ceramic or porcelain serving tray.

### BRIEF SUMMARY OF THE INVENTION

Briefly stated, a preferred embodiment of the present application is directed to a method of painting on a generally planar ceramic surface in a food safe manner. The method includes the steps of cleaning the surface with a food safe cleaning agent, preparing a food safe paint to apply to the surface, painting the surface with the food safe paint in an aesthetically pleasing manner, resting the surface for a predetermined dwell time and heating the painted surface to at least three hundred degrees Fahrenheit (300° F.) for at least thirty minutes (30 min). The predetermined dwell time is at least twelve hours (12 hrs).

In another aspect, a preferred embodiment of the present application is directed to a method of painting on a ceramic tile having a generally planar surface in a food safe manner. The method includes the steps of drilling first, second, third and fourth holes in the tile proximate first, second, third and fourth corners, respectively, cleaning the surface with a food safe cleaning agent, preparing a food safe paint to apply to the surface, painting the surface with the food safe paint in an aesthetically pleasing manner, resting the surface for a predetermined dwell time, heating the painted surface to at least three hundred degrees Fahrenheit (300° F.) for at least thirty minutes (30 min), resting the surface for a cooling time of at least twelve hours (12 hrs), repeating the cleaning step, painting a customized painting onto the surface and repeating the resting and heating steps. The predetermined dwell time is at least twelve hours (12 hrs).

### BRIEF DESCRIPTION OF THE DRAWINGS

The foregoing summary, as well as the following detailed description of the invention, will be better understood when read in conjunction with the appended drawings. For the purpose of illustrating the invention, there is shown in the drawings an embodiment which is presently preferred. It should be understood, however, that the invention is not limited to the precise arrangements and instrumentalities shown. In the drawings:

FIG. 1 is a top perspective view of a food safe serving tray in accordance with a preferred embodiment of the present application;

FIG. 2 is a front perspective view of the tray of FIG. 1; and

FIG. 3 is a bottom plan view of a ceramic tile of the tray of FIG. 1.

### DETAILED DESCRIPTION OF THE INVENTION

Certain terminology is used in the following description for convenience only and is not limiting. The words “right,” “left,” “lower,” and “upper” designate directions in the drawings to which reference is made. The words “inwardly” or “distally” and “outwardly” or “proximally” refer to directions toward and away from, respectively, the geometric center or orientation of the preferred tray and related parts thereof. The terminology includes the above-listed words, derivatives thereof and words of similar import.

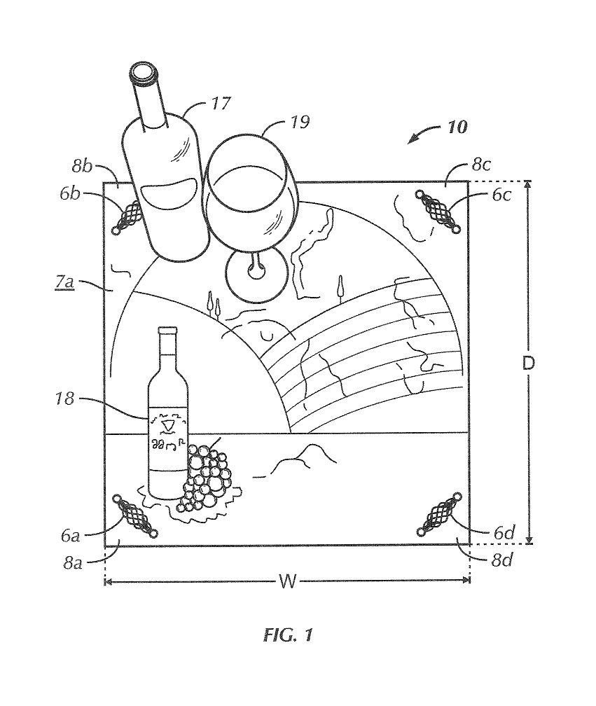

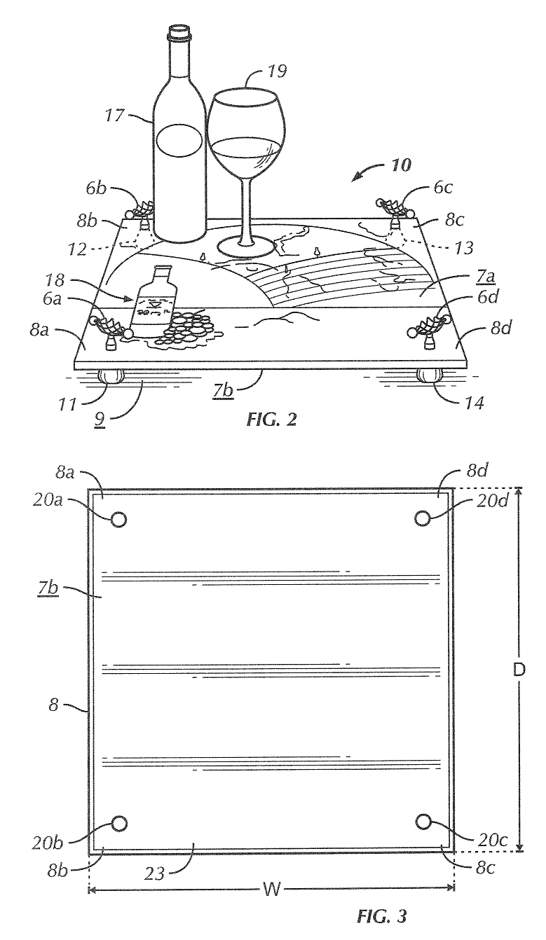

Referring to FIGS. 1 and 2, a food safe, aesthetically pleasing serving tray 10 in accordance with the preferred embodiment is constructed of a ceramic or porcelain tile 8 elevated above the floor or a support surface 9 by four upright legs 11, 12, 13, 14, including a first leg 11, a second leg 12, a third leg 13 and a fourth leg 14. The number of legs 11, 12, 13, 14 used to support the tile 8 could be increased or reduced at the discretion of the designer or user, depending upon preferences or functional considerations. For example, the serving tray 10 may include eight (8) legs (not shown) spaced about a relatively octagonal tile 8 to create a pleasing and unique aesthetic appearance, a triangular-shaped tile 8 may include three (3) legs or the serving tray 10 may be otherwise configured based on designer or user preferences. Each of the legs 11, 12, 13, 14 is preferably attached to the underside or rear surface 7b of the tile 8 near or proximate a corner 8a, 8b, 8c, 8d of the tile 8 and extends generally perpendicularly from the rear surface 7b. Corresponding handles 6a, 6b, 6c, 6d are preferably connected to the legs 11, 12, 13, 14, respectively, by a threaded piece of metal or other material (not shown), which goes through holes 20a, 20b, 20c, 20d drilled in the tile 8, preferably using a diamond industrial strength drill bit and a drill press (not shown). The tray 10 is not limited to inclusion of the legs 11, 12, 13, 14, handles 6a, 6b, 6c, 6d and/or holes 20a, 20b, 20c, 20d or forming the holes 20a, 20b, 20c, 20d by drilling using the diamond industrial strength drill bit and drill press. For example, the tray 10 may be constructed without the legs 11, 12, 13, 14 and handles 6a, 6b, 6c, 6d, thereby making the need for the holes 20a, 20b, 20c, 20d obsolete or the legs 11, 12, 13, 14 and/or handles 6a, 6b, 6c, 6d may be fastened, adhesively bonded, clamped or otherwise secured to the tile 8. However, the legs 11, 12, 13, 14 and/or handles 20a, 20b, 20c, 20d are preferably included with the tray 10 to provide an aesthetically pleasing appearance, raise the tray 10 off of the support surface 9 and provide convenience in carrying and/or moving the tray 10 using the handles 6a, 6b, 6c, 6d.

The tile 8 is preferably, sufficiently wide and long for comfortable serving of food in the center of the tray 10. In the preferred embodiment, the tile 8 has a depth D of about twelve to twenty-four inches (12-24″) and a width W of about twelve to twenty-four inches (12-24″). The tray 10 is preferably large enough to accommodate a bottle of wine 17 and a glass 19 on a front surface 7a, as well as providing additional space for use as a cutting surface for meats, cheeses or other foodstuffs. The legs 11, 12, 13, 14 are preferably sufficiently tall to position the tile 8 and its front surface 7a a comfortable distance off the table or support surface 9, such as about one quarter to three inches (¼-3″) off of the support surface 9. The tile 8 is not limited to having the above-listed dimensions or to have any particular size and/or shape and may be comprised of a rounded, triangular, curved, bowl-shaped or other shape that is able to facilitate the preferred method of the present application. In addition, the tray 10 is not limited to including the legs 11, 12, 13, 14 and may be constructed such that the rear surface 7b rests directly on the support surface 9 or with integrally formed legs (not shown) that extend from the rear surface 7b.

The tile 8 is preferably constructed of a ceramic or porcelain material or of any other material having a relatively high rigidity, hardness and strength such as high-strength plastic, metal, and the like. Further, the various components of the serving tray 10 can be made of different materials, such as the legs 11, 12, 13, 14 and/or the handles 6a, 6b, 6c, 6d or other accessories utilized with the tray 10. For example, the legs 11, 12, 13, 14 and handles 6a, 6b, 6c, 6d are constructed of a metallic material in the preferred embodiment.

The tile 8 is preferably prepared by cleaning the front and rear surfaces 7a, 7b with a food safe cleaning solution or agent. A food safe paint is then prepared to apply to the tile 8, preferably to at least the front surface 7a, but the paint may be applied to all surfaces of the tile 8. The tile 8 is then painted in an aesthetically pleasing manner. A background is preferably initially painted on the front surface 7a of the tile 8, which may be chosen by the artist. The background is preferably painted using food safe porcelain paints that are safe for serving food or non-food safe porcelain paint if the tray 10 will be used exclusively for decorative purposes. The tile 8 with the background painted thereon is preferably left to rest or dry for a predetermined dwell time. The predetermined dwell time is preferably at least twelve hours (12 hrs) and more preferably at least twenty-four hours (24 hrs). The predetermined dwell time is not limited to twelve (12) and/or twenty-four hours (24 hrs) and may be nearly any amount of time that permits the background paint to initially dry and set on the tile 8.

Following the predetermined dwell time, the tile 8 is preferably heated to at least three hundred degrees Fahrenheit (300° F.), more preferably to at least three hundred twenty-five degrees Fahrenheit (325° F.) for at least thirty minutes (30 min) and more preferably for at least thirty-five minutes (35 min). Higher or lower temperatures and time periods are also possible in an electric kiln, wood burning oven, furnace, cooking oven, or other such heating appliance as determined by the manufacturer based on the paint mix used, environmental conditions, the tile 8 or other factors.

A customized painting 18, such as a customized or personalized bottle of wine 18 shown in FIGS. 1 and 2, is then preferably painted on a first corner 8a of the tile 8, as shown FIG. 1 or in the center of the tile 8 using food safe porcelain paints if the tray 10 is to be used for serving food, or non-food safe porcelain paints if the tray 10 will be used for decorative purposes. This customized painting 18 could be an item that is important to the artist, customer or user, such as a family emblem, a vase, a favorite bottle of wine, an important symbol or nearly any depiction that may be recreated on one of the surfaces 7a, 7b of the tile 8.

In the preferred embodiment, the paint mix used is prepared using ceramic, porcelain, water, or any other food safe paint. An example of such a paint is Pebeo Porcelain 150, number EMB 13042b, made by Pebeo of BP 106-3881 Ceded, France. Once the bottle of wine or other decoration 18 is painted on the tile 8, the tile 8 is preferably left to dry for the predetermined dwell time. In the preferred embodiment, the predetermined dwell time is preferably at least twelve hours (12 hrs) and more preferably at least twenty-four hours (24 hrs). The tile 8 is then preferably heated to at least three hundred degrees Fahrenheit (300° F.), more preferably to at least three hundred twenty-five degrees Fahrenheit (325° F.) for at least thirty minutes (30 min) and more preferably for at least thirty-five minutes (35 min). Higher or lower temperatures and predetermined dwell times are also possible in an electric kiln, wood burning oven, furnace, cooking oven, or other such heating appliances as determined by the manufacturer, artist or ultimate user based on the paint mix used. For example, the tile 8 may be heated in an industrial kiln to approximately one thousand degrees Fahrenheit (1000° F.) after painting and resting for the predetermined dwell time. Such a relatively higher curing temperature may assist in integrating the paint into the surfaces 7a, 7b of the tile 8 such that the tray 10 is more durable and resistant to scratching of the background and/or customized painting 18.

Each of the legs 11, 12, 13, 14 is preferably attached to the rear surface 7b of the tile 8 near or proximate the corners 8a, 8b, 8c, 8d of the tile 8 and the legs 11, 12, 13, 14 are each preferably connected to the corresponding handles 6a, 6b, 6c, 6d, respectively, by a threaded piece of metal or other material which goes through holes 20a, 20b, 20c, 20d drilled in the tile 8. The holes 20a, 20b, 20c, 20d are preferably formed by drilling into the tile 8 using the diamond industrial strength drill bit and a drill press (not shown). The holes 20a, 20b, 20c, 20d take precision, delicacy and skill to drill since they are preferably positioned in close proximity to the corners 8a, 8b, 8c, 8d of the tile 8. The drilling process is relatively delicate due to the relatively hard and brittle nature of the ceramic tile 8. However, the holes 20a, 20b, 20c, 20d are not limited to being drilled proximate the corners 8a, 8b, 8c, 8d and may be formed, punched or not included in the tile 8, without departing from the broad inventive concept herein.

In the preferred embodiment, the tile 8 preferably includes a cork base 23 to make the rear surface 7b more aesthetically pleasing and improve durability. The cork board 23 is preferably attached to the rear surface 7b using food safe glue and is glued on after the heating process, but is not so limited and may be secured to the rear surface 7b in nearly any manner, such as fastening, screwing, clamping or nearly any other securing mechanism or method that mounts the cork base 23 to the rear surface 7b. In addition, the tray 10 is not limited to inclusion of the cork base 23 and the rear surface 7b may be left exposed in the assembled configuration, thereby permitting display of the background and/or a custom painting defined on the rear surface 7b.

The assembled tray 10 is preferably, aesthetically pleasing, meaningful to the owner as it represents something special such as a favorite bottle of wine with the custom painting 18 or other item. The tray 10 is preferably able it stimulate good conversation and a pleasant social effect as a conversation starter in a social setting. The paint is preferably baked into the tile 18, such that the paint does not come off of the tile 8 even if a knife is used to cut food such as cheese or fruit on the front surface 7a when the cheese or fruit is placed on the tray 10. The tray 10 is preferably portable and relatively easy to transport, but is not so limited and may have nearly any size and shape, such as a size that results in a tray 10 that is generally fixed in a single location. However, the tray 10 is preferably easy to move to any place, either inside or outside a house or office because of its relatively small and lightweight configuration. Moving the tray 10 typically requires a single person and food can be served practically anywhere by resting the desired foodstuff on the front surface 7a and transporting the tray 10 and food by grasping the handles 6a, 6b, 6c, 6d and carrying the foodstuff and tray 10 to the desired location. Further, the preferred tray 10 will generally pass through most doorways without any widening. In addition, the preferred tray 10 can be easily moved from spot to spot once inside a room.

Heating or curing of the paint after painting and the predetermined dwell time are not limited to the above-described cooking or curing temperatures. For example, the painted tile 8 may be heated to three hundred degrees Fahrenheit (300° F.) to one thousand one hundred degrees Fahrenheit (1100° F.). More preferably, the painted tile 8 may be heated to three hundred degrees Fahrenheit (300° F.) to four hundred degrees Fahrenheit (400° F.). Alternatively, the tile 8 may be heated and cured at a temperature of three hundred twenty five degrees Fahrenheit (325° F.). The heating and curing of the painted tile 8 is not necessarily limited to any particular temperature and may be cured or heated as desired by the user or recommended by the manufacturer of the paint.

In addition, the above-described predetermined dwell time to permit the surfaces 7a, 7b of the tile 8 to rest after painting is not limited to twelve hours (12 hrs). For example, the dwell time may be at least twenty four hours (24 hrs) or nearly any amount of time recommended by the paint manufacturer or desired by the artist or user. The predetermined dwell time permits the paint to initially dry or cure relatively slowly and the subsequent preferred heating or curing at increased temperatures improves setting or adhesion of the paint to the tile 8.

In the preferred embodiment, the tile 8 is preferably a rectangular or square tile 8. The holes 20a, 20b, 20c, 20d are preferably located at the corners 8a, 8b, 8c, 8d of the tile 8 to space the legs 11, 12, 13, 14 and handles 6a, 6b, 6c, 6d about the tray 10.

In the preferred embodiment, the customized painting 18 covers less than fifty percent (50%) of an area of the front surface 7a and the background paint covers the entire front surface 7a. The background painting is not limited to covering one hundred percent (100%) of the front surface 7a and the customized painting 18 is not limited to covering less than fifty percent (50%) of the front surface 7a. For example, the background painting may only cover a portion of the front surface 7a and the customized painting 18 may cover nearly the entire front surface 7a and extend onto the rear surface 7b. The background and customized painting 18 may cover nearly any portion and be located nearly anywhere on the tile 8, as desired by the artist and/or user.

After the painted tile 8 has been cured via heating in the oven or other heating or baking device, the tile 8 is preferably allowed to rest for a cooling time before any additional processes are undertaken. In the preferred embodiment, the cooling time is at least twelve hours (12 hrs), but is not so limited and may be less or more depending upon the heating cycle used, the materials, the paint or other related factors. The cooling time is preferably at least twelve hours (12 hrs) following painting of the background and prior to any cleaning, preparation or other manipulation of the tile 8 prior to applying the customized painting 18. Providing the appropriate cooling time prior to applying the customized painting 18 limits the chance that the relatively high temperature of the tile 8 impacts adhesion of the paint when applied for creation of the customized painting 18. In addition, the cooling time is preferred for safety purposes to limit chances that the artist is burned or otherwise injured by a hot tile 8, due to the insulating nature of porcelain and ceramic materials and their tendency to retain heat energy.

It will be appreciated by those skilled in the art that changes could be made to the embodiments described above without departing from the broad inventive concept thereof. It is understood, therefore, that this invention is not limited to the particular embodiment disclosed, but is intended to cover modifications within the spirit and scope of the present invention as defined by the appended claims.

We claim:

1. A method of painting on a generally planar ceramic front surface in a food safe manner, the method comprising the steps of:
a) cleaning the front surface with a food safe cleaning agent;
b) preparing a food safe paint to apply to the front surface;
c) painting the front surface with the food safe paint in an aesthetically pleasing manner;
d) resting the front surface after step (c) for a predetermined dwell time, the predetermined dwell time being at least twelve hours (12 hrs); and
e) heating the painted front surface of step (c) to at least three hundred degrees Fahrenheit (300° F.) for at least thirty minutes (30 min).

2. The method of claim 1 wherein the painted front surface of step (d) is heated to three hundred degrees Fahrenheit (300° F.) to one thousand one hundred degrees Fahrenheit (1100° F.).

3. The method of claim 2 wherein the painted front surface of step (d) is heated to three hundred degrees Fahrenheit (300° F.) to four hundred degrees Fahrenheit (400° F.).

4. The method of claim 1 wherein the predetermined dwell time is at least twenty-four hours (24 hrs).

5. The method of claim 1 comprising the further step of:
f) drilling holes in the ceramic front surface.

6. The method of claim 5 wherein the ceramic front surface is associated with a generally rectangular tile, the holes comprising first, second, third and fourth holes located proximate corners of the tile, respectively.

7. The method of claim 6 comprising the further step of:
f) mounting first, second, third and fourth legs to the tile at the first, second, third and fourth holes, respectively.

8. The method of claim 6 comprising the further step of:
f) mounting first, second, third and fourth handles to the tile at the first, second, third and fourth holes, respectively.

9. The method of claim 1 wherein the ceramic front surface is associated with a generally rectangular tile, the tile including a rear surface opposite the front surface, the rear surface being painted in step (c).

10. The method of claim 1 comprising the further steps of:
f) resting the front surface after step (e) for a cooling time of at least twelve hours (12 hrs);
g) repeating step (a);
h) painting a customized painting onto the front surface; and
i) repeating steps (d) and (e).

11. The method of claim 10 wherein the front surface is associated with a generally rectangular tile having first, second, third and fourth corners, the customized painting being located adjacent the first corner.

12. The method of claim 10 wherein the customized painting depicts a wine bottle.

13. The method of claim 10 wherein the customized painting covers less than fifty percent (50%) of an area of the front surface.

14. A method of painting on a ceramic tile having a generally planar front surface in a food safe manner, the method comprising the steps of:
a) drilling first, second, third and fourth holes in the tile proximate first, second, third and fourth corners, respectively;
b) cleaning the front surface with a food safe cleaning agent;
c) preparing a food safe paint to apply to the front surface;
d) painting the front surface with the food safe paint in an aesthetically pleasing manner;
e) resting the front surface after step (c) for a predetermined dwell time, the predetermined dwell time being at least twelve hours (12 hrs);
f) heating the painted front surface of step (c) to at least three hundred degrees Fahrenheit (300° F.) for at least thirty minutes (30 min);
g) resting the front surface after step (e) for a cooling time of at least twelve hours (12 hrs);
h) repeating step (b);
i) painting a customized painting onto the front surface; and
j) repeating steps (e) and (f).

15. The method of claim 14 wherein the customized painting covers greater than fifty percent (50%) of the front surface.

16. The method of claim 14 comprising the further steps of:
k) mounting first, second, third and fourth legs to the tile in the first, second, third and fourth holes, respectively; and
l) mounting first, second, third and fourth handles to the tile in the first, second, third and fourth holes, respectively, the tile including a rear surface opposite the front surface, the first, second, third and fourth handles extending generally perpendicular to the front surface and the first, second, third and fourth legs extending generally perpendicular to the rear surface.

17. The method of claim 14 wherein the tile includes a rear surface opposite the front surface, the first, second, third and fourth holes extending through the front surface and the rear surface.

18. The method of claim 14 wherein the tile includes a rear surface opposite the front surface, the painting of step (d) is comprised of a background painting that covers approximately one hundred percent (100%) of the front surface and the customized painting of step (i) covers less than fifty percent (50%) of the front surface.

19. The method of claim 14 wherein the temperature of step (f) is three hundred twenty-five degreed Fahrenheit (325° F.).

20. The method of claim 14 wherein the dwell time is twenty-four hours (24 hrs) and the cooling time is twenty-four hours (24 hrs).
